(19) United States
(12) Patent Application Publication
(10) Pub. No.: US 2009/0188861 A1
(43) Pub. Date: Jul. 30, 2009

(54) Preventing and cleaning fouling on reverse osmosis membranes

(75) Inventor: Roslyn Higgin, Albuquerque, NM (US)

Correspondence Address: Mr. Edward J. Timmer, P. O. Box 770, Richland, MI, 49083-0770, US

(73) Assignee: STC. UNM

(21) Appl. No.: 12/316,366

(22) Filed: Dec. 11, 2008

Related U.S. Application Data
(60) Provisional application No. 61/007,472, filed on Dec. 13, 2007.

(51) Int. Cl. B01D 65/02

(52) U.S. Cl. 210/636

(57) ABSTRACT

A method of controlling fouling of a reverse osmosis membrane disposed in an aqueous medium by an inorganic foulant involves providing a fouling control agent comprising an acidic polysaccharide such as alginic acid fouling control agent dissolved in the aqueous medium in an amount effective to reduce, reverse, or prevent fouling by an inorganic foulant.

This application claims benefits and priority of provisional application Ser. No. 61/007,472 filed Dec. 13, 2007, the disclosure of which is incorporated herein by reference.

### BACKGROUND OF THE INVENTION

1. Field of the Invention

The present invention pertains to reverse osmosis membranes, and more particularly, and not as a way of limitation, to a method of controlling fouling of a reverse osmosis membrane disposed in an aqueous medium by providing a fouling control agent comprising an acidic polysaccharide in the aqueous medium to reduce, reverse, or prevent fouling.

2. Description of the Background Art

Reverse osmosis has become an accepted and relatively common treatment technology for the removal of dissolved solutes from water. Seawater desalination for potable water production is a common application, but reverse osmosis is also used to treat inland waters for applications involving softening, specific contaminant removal, wastewater reuse, and brackish water desalination. In addition, reverse osmosis is used for industrial purposes. Reverse osmosis is an expensive and energy intensive process and the cost effectiveness can be negatively impacted by fouling of the membranes. The wide variety of source waters and applications leads to a wide variety of fouling problems.

It is known that dissolved substances can be separated from their solvents by the use of various types of selective membranes, such selective membranes including, listed in order of increasing pore size: reverse osmosis membranes, ultrafiltration membranes and microfiltration membranes.

One use to which reverse osmosis membranes have previously been put is in the desalination of brackish water or seawater to provide large volumes of relatively non-salty water suitable for industrial, agricultural or home use. What is involved in the desalination of brackish water or seawater using reverse osmosis membranes is literally a removal of salts and other dissolved ions or molecules from the salty water by forcing the salty water through a reverse osmosis membrane whereby purified water passes through the membrane while salts and other dissolved ions and molecules do not pass through the membrane. Osmotic pressure works against the reverse osmosis process and the more concentrated the feed water, the greater the osmotic pressure which must be overcome.

A reverse osmosis membrane, in order to be commercially useful in desalinating brackish water or seawater on a large scale, must possess certain properties. One such property is that the membrane has a high salt rejection coefficient. In fact, for the desalinated water to be suitable for many commercial applications, the reverse osmosis membrane should have a minimum salt rejection capability of about 97%. Another important property of a reverse osmosis membrane is that the membrane possesses a high flux characteristic, i.e., the ability to pass a relatively large amount of water through the membrane at relatively low pressures. For certain applications, a rejection rate that is less than that which would otherwise be desirable may be acceptable in exchange for higher flux and vice versa.

Such a reverse osmosis composite membrane is suitable for manufacturing ultra-pure water, desalinating brackish water, and the like, and it also can contribute to the removal and recovery of the contaminating sources or effective substances from a soil or the like, the cause of pollution in a dyeing waste water system, an electrochemical deposition paint waste water system, or a domestic waste water system to implement a waste water recycling system. In particular, it can operate stably for a long period with respect to the quality of water containing various membrane-fouling substances, such as surfactants and transition metal components including iron, which cause a decrease in flux.

The use of reverse osmosis devices to remove contaminants from water is well established in the art and many such devices exist. Originally used primarily in the industry, smaller and smaller devices are being developed and are now suitable for use in residential applications. Indeed, there is an increased demand for such residential devices as concern with the purity of residential water increases. One of the major concerns with the use of reverse osmosis devices is the percentage of water that is sent to the drain and the fouling of the membrane of the reverse osmosis system.

In general, a reverse osmosis membrane has been applied to various fields, such as desalination of sea water, wastewater treatment, production of ultra pure water, treatment of purified water for households or for commercial/non-commercial boats, and the like. With a view of increasing water permeability of the membrane or improving removal of salt, research for such reverse osmosis has been carried out. In this regard, U.S. Pat. No. 4,872,984 to Tomashke and U.S. Pat. No. 4,983,291 to Chau discloses a novel polyamide reverse osmosis membrane, capable of increasing water permeability and improving the removal of salt.

One problem encountered by many of the various composite polyamide reverse osmosis membranes described above is fouling, i.e., the undesired adsorption of solutes to the membrane, thereby causing a reduction in flux exhibited by the membrane. Fouling is typically caused by hydrophobic-hydrophobic and/or ionic interactions between the polyamide film of the membrane and those solutes present in the solution being filtered. As can readily be appreciated, fouling is undesirable not only because it results in a reduction in flux performance for the membrane but also because it requires that operating pressures be varied frequently to compensate for the variations in flux experienced during said reduction. In addition, fouling also requires that the membrane be cleaned frequently.

Meanwhile, reverse osmosis membrane has been applied to a treatment for water containing fouling substances such as various surfactants, for example, sewage, pharmaceutical products, semiconductor production, and beverages products. In addition to the high performance of the reverse osmosis membrane (a high salt rejection and high water permeability), a high fouling resistance is required to maintain the desired flux for a long period.

Water treatment processes using the reverse osmosis membrane also suffer from fouling. As described above, and in this case, fouling is the deposition of material, referred to as foulant, on the membrane surface or in its pores, leading to a change in membrane behavior or even complete plugging of the membrane. These phenomena manifest themselves over time by increased operating pressure whereby water permeability properties, such as water permeability or removal of salt, are decreased. There is a widely recognized need for fundamental preventive measures.

Examples of the foulant classified by form include inorganic crystalloids, organic contaminants, particulate matters and colloids, and microorganisms. Fouling can be caused by particles, inorganic scaling, biofilms, or organic matter. Particle fouling is frequently controlled by appropriate pretreatment. Several studies have autopsied membranes and found the most egregious foulants are silica and biofilms (Nederlof et al., 2005; Lisitsin et al., 2005). The formation of inorganic scale deposits on membranes is a pervasive and expensive problem for the water treatment industry. The common strategies for controlling inorganic scaling are to limit the process recovery and/or to feed antiscalants. The main mechanism for many antiscalants is to inhibit crystal formation. These scale inhibitors are often ineffective for silica precipitates because silica forms an amorphous solid rather than a crystalline solid (Semiat, et al. 2003). Several studies show that silica fouling decreases the efficiency of reverse osmosis membranes and disturbs the desalination process. Semiat et al. (2003) describes silica fouling as a complex process and not well understood, and further stresses the importance of finding an efficacious antiscalant as ‘the last frontier in scale control.’

Many of the research studies that have investigated the problems of and solutions to reverse osmosis fouling have focused on a single cause of fouling. For instance, Sheikholeslami et al. (1999), Weng et al. (1995), and Hamrouni et al. (2001) each studied silica fouling as a singular problem, finding that silica fouling on reverse osmosis membranes used in desalination of seawater and brackish water decreases energy efficiency due to high drops in pressure. Other researchers have focused solely on problems caused by biofilms (Nederlof, et al. 2005). Biofilm that forms on reverse osmosis membranes prevents the water from penetrating through the membrane and, thereby, decreases the efficiency, decreases permeate water quality, and increases cleaning of membranes and the need to replace membranes.

Fouling is complex, however, and the combined impact of more than one foulant may be substantially different from the sum of the individual effects. Thus, it is necessary to consider synergistic effects of the presence of multiple foulants. For instance, Lee and Elimelech (2006) found a strong synergistic effect when colloids and dissolved natural organic matter were both present in reverse osmosis feed water compared to fouling caused by each foulant individually. Silica and biological/organic fouling is now discussed.

### A) Silica Fouling

Silicates are the most abundant material on the earth's crust and are composed of mainly oxygen and silicon (Si0₂). Silica is a 3-dimensional network with an oxygen atom located at the corners of the tetrahehedron crystalline structure. If the atoms are in a random order, silica exists in a noncrystalline solid also known as amorphous silica.

In natural waters, silica often has a concentration within 1 to 30 mg/L, but the concentrations in groundwater can be as high as 150 mg/L, especially in the Southwestern United States. In natural waters, silica exists in its hydrated form H₄SiO₄ or Si(OH)₄.

The solubility of silica varies greatly because of the different forms in which it exists naturally. Silica is a mineral that occurs in sand, sandstone, and diatomaceous earth. Temperature is a strong determining factor of its solubility. Studies show that silica, in the form of quartz, is soluble at a concentration of 6.0 mg/L at 25° C. At 84° C., the solubility of quartz increases to 26 mg/L. Amorphous silica is less sensitive to temperature. For example, it has a solubility of 115 mg/L at 25° C., and 370 mg/L at 100° C. (Crittenden et al., 2005).

Research has shown that silica is a severe scalant and greatly diminishes the effectiveness of reverse osmosis. One study shows permeability decline effects with increasing silica-bearing saline solution (Semiat et al., 2003). The study shows at low silica concentrations scale deposition is primarily due to monomeric dissolved silica, and at high silica concentrations the scale deposition is due to polymerized colloidal particles. Additional studies on silica fouling investigate increasing silica concentrations from 100 mg/L to 200 mg/L and permeation declines due to fouling. Research by Sheikholeslami et al. (2000) examines the mechanism of silica fouling on reverse osmosis membranes in the presence of calcium and magnesium. A study on the desalination of brackish waters in the south of Tunisia (North Africa) shows the impact silica fouling has on reverse osmosis membranes and the solubility of silica at different temperatures, pH and ionic strength (Hamrouni et al., 2001).

For effective operation, the ASTM D4993-89 industry guidelines state the maximum silica concentration should be 120 mg/L at 25° C. A study by Freeman and Majerle (1995) shows this limit may be exceeded in certain applications. Freeman and Majerle (1995) also discuss the effect of variables, such as temperature, pH, time, and metal ions on silica fouling on RO membranes.

### B) Biological/Organic Fouling

Microorganisms are a major organic contributor to fouling. They have the ability to attach to any surface and once firmly attached, they grow, reproduce, and produce extracellular polymeric substances (EPS), an impenetrable biofilm, which decreases permeate flow (Nederlof et al., 2005). Biofilms enable microorganisms to sustain life in very critical environmental conditions (Anwar et al., 1992). EPS, also known as glycocalyx or slime is the fixative or glue that protects the bacteria (Heukelekian et al., 1940). Within the biofilm exists exogenous substances, nucleic acids, proteins, minerals, nutrients, and cell wall material (Costerton et al., 1987). The biofilm consists of heterogeneous organisms and thousands or millions of diverse species. The biofilm is a structured matrix layered with organisms that are dead, oocysts, spores, or preying on smaller organisms. Microorganisms colonize to form a biofilm. Once attached to the membrane, biofilms increase the hydraulic resistance leading to permeate flux decline or increased operating pressure to maintain desired flux. Frequency of chemical cleaning also increases, resulting in a decrease in the life of the membrane (Ng, 2005). Biofouling phenomena are the least understood and, therefore, the least controllable of all fouling phenomena (Nederlof et al., 2005).

Alginic acid or sodium alginate is often used as a surrogate for EPS in membrane fouling studies. Alginic acid is a polysaccharide that is composed of repeating manuronic and guluronic acids with pKa values of 3.38 and 3.65, respectively, and is produced naturally by bacteria and algae in wet environments (Davis et al., 1995, Lee et al., 2006). It is a weak acid with a molecular formula of C₆H₇NaO₆ and a molecular weight of 32,000-250,000 g/mole.

Several studies have used alginic acid as a substitute to study the behavior of biofilms on membrane processes. Research conducted by Lee, et al (2006) used alginic acid to study the organic fouling on reverse osmosis membranes caused by effluent organic matter (EfOM). Their interest was on pretreated secondary effluent from wastewater that contains a high amount of EfOM that, as stated earlier, contributes significantly to the fouling of reverse osmosis membrane processes.

In order to decrease the fouling, pretreatment of water, modification of electrical properties of the membrane surface, modification of module process condition, and periodical cleaning are widely utilized. Recently, work to produce membranes with antifouling properties has focused on change of electrical charge characteristics of the membrane surface. But, the fact is that a novel membrane, capable of drastically decreasing the fouling, is not developed yet.

In the reverse osmosis system, it is normal practice to dispose of the concentrate to prevent fouling of the membrane. Naturally, this results in a substantial waste of water. Every so often, the membrane must be cleaned. While this cleaning is normal and done on a regular basis, each cleaning reduces the efficiency and integrity of the membrane. Accordingly, the number of cleanings will dictate the timing for replacement of the membrane and the cost associated therewith.

### SUMMARY OF THE INVENTION

The present invention relates to a method of controlling fouling of a reverse osmosis membrane disposed in an aqueous medium. The method involves providing a fouling control agent comprising an acidic polysaccharide in the aqueous medium. The fouling control agent is provided in the aqueous medium in an amount effective to reduce, reverse, or prevent fouling by an inorganic foulant including, but not limited to, silica and others. The fouling control agent can be introduced into the aqueous medium before it contacts the membrane to prevent fouling. The fouling control agent also can be introduced into the aqueous medium after the membrane is at least partially fouled to reverse fouling.

In an illustrative embodiment of the invention, the fouling control agent preferably comprises an exopolysaccharide and even more preferably an alginic acid fouling control agent that includes, but is not limited to, alginic acid, alginate and the like and that is dissolvable in water when the foulant comprises a silicon compound and/or a sodium compound. The alginic acid fouling control agent can be present in an amount of at least about 40 mg/L of the aqueous medium to reduce fouling. It can be present in an amount of at least about 80 mg/L to reverse existing fouling of the membrane. In a particular embodiment of the invention, the fouling control agent is provided in the aqueous medium of the RO system having a aqueous pressure of about 14 bar to about 28 bar and a cross-flow velocity of about 0.3 m/s to about 0.6 m/s wherein the cross-flow velocity is flow rate of the aqueous medium parallel to the reverse osmosis membrane.

Practice of the present invention is advantageous to provide a reduction in the costs of membrane replacement for industries that currently can afford the expense of reverse osmosis water treatment, and will enable other industries, municipalities, nationally and internationally, i.e., drought ridden third-world countries, affordable access to clean water. Other advantages of the present invention will become more readily apparent from the following detailed description taken with the following drawings.

### BRIEF DESCRIPTION OF THE DRAWINGS

FIG. 1 illustrates fouling of RO membrane by silica evidenced by reductions in normalized permeate flux experiments at 0.3 m/s and 27.6 bar.

FIG. 2 illustrates a relationship between J/k and flux decline.

FIG. 3 illustrates fouling of RO membrane by a combination of alginic acid and silica at low cross-flow velocity 0.3 m/s.

FIG. 4 illustrates fouling of RO membrane by a combination of alginic acid and silica at high cross-flow velocity 0.6 m/s.

FIG. 5 illustrates removal of silica scale by the addition of alginic acid. Silica was introduced at 2 hours and alginic acid was introduced at 28 hours.

FIG. 6 is a schematic view of the bench-scale flat sheet cross-flow membrane cell.

### DETAILED DESCRIPTION OF THE DRAWINGS

For purposes of illustration and not limitation, the present invention will be illustrated with respect to experiments performed wherein individual foulants were run to characterize the effect on membrane fouling at different velocities and pressures. Then a series of experiments were run using a combination of the two foulants to characterize any synergistic effects on RO membrane fouling. The foulants chosen for the experiments were silica as an inorganic foulant and alginic acid (alginate) as an initially-perceived biofoulant based on past experience that silica and alginic acid promoted severe fouling on RO membranes. The present invention relates to the unexpected discovery from the experiments that an acidic polysaccharide such as alginic acid can function as a fouling control agent in the presence of silica under certain RO conditions described below such that interactions between silica and alginate result in less fouling than was observed when silica was present in solution by itself. Moreover, the addition of alginate to the feed solution after fouling by silica had already occurred was able to restore the flux to near the original value. These results indicated that a cleaning solution containing alginate may be able to restore membrane performance after silica scaling has occurred. The results are significant because silica scaling is particularly challenging to prevent or reverse because of the amorphous nature of silica precipitates. Antiscalants and cleaning solutions that are used for other inorganic scaling problems are often ineffective on silica.

The invention can be practiced using a fouling control agent comprising an acidic polysaccharide such as an exopolysaccharide. More particularly, an alginic acid fouling control agent can be used and includes, but is not limited to, alginic acid, alginate and the like. A preferred fouling control agent comprises alginic acid sodium salt or other alginic acid salt that is dissolvable in water. The inorganic foulant can include, but is not limited to, silica, sodium bicarbonate, and others.

The following experimental examples are offered to illustrate the invention in more detail and not limit the scope of the invention:

The experiments were conducted at bench-scale using synthetic feed water. The feed solution was deionized water buffered with 2 mM sodium bicarbonate and the pH was adjusted with hydrochloric acid to approximately 8.0 during each experiment. Alginic acid (type A2158 alginic acid sodium salt from brown algae purchased from Sigma-Aldrich) was used as the biofoulant. The alginic acid additive was prepared by dissolving dry alginic acid sodium salt powder in one liter of deionized water with stirring and heating (warming) for about one hour and then filtering the solution through a 0.45 μm filter followed by adding the solution to the feed vessel or tank (20 liters) to achieve the alginic acid concentrations used (see Table 1). Silica additive was prepared in similar manner using sodium metasilicate nonahydrate (Na₂SiO₃-9H₂O from Fisher Scientific) and added to the feed tank to achieve the silica concentrations used. The experiments were conducted in a laboratory flat sheet cross-flow membrane cell commercially available from GE Osmonics SEPA CF-II and held in a GE Osomnics cell holder, FIG. 6. The cross-flow membrane cell is shown in FIG. 6. The feed pump shown in FIG. 6 was provided for supplying feed water to the cell. The feed water pump was a 3-piston Wanner Hydracell pump controlled by a Leeson Speedmaster variable speed drive, which controlled the cross-flow velocity of the flow through the membrane 10 of the SEPA cell. Feed and permeate flow, pressure, conductivity and temperature were monitored continuously using a data acquisition system (National Instruments LabView). The feed water temperature was kept constant at 25° C. using a circulator (Thermo Neslab RTE-7). Feed and permeate flow, pressure, conductivity and temperature were monitored continuously using a data acquisition system (National Instruments LabView). An RO polyamide thin-film composite membrane comprised a commercially available Osmonics polyamide RO AG membrane and was used for all experiments. The feed channel spacer was 34 mil.

In the GE Osmonics SEPA CF-II cross-flow membrane cell of FIG. 6, a single piece of rectangular membrane is installed in the cell body bottom shown on top of the feed spacer and shim (optional). Guideposts shown assure proper alignment of the membrane. The permeate carrier is placed into the cell body top, which fits over the guideposts. Guidepost location assures proper orientation of the cell body halves. The cell body is inserted into the cell holder shown, and hydraulic pressure is applied to the bottom of the holder. This pressure causes the piston to extend upward and compress the cell body against the cell holder top. Double O-rings in the cell body provide a leak-proof seal. The feed stream is pumped from the feed vessel to the feed inlet, which is located on the cell body bottom. Flow continues through a manifold into the membrane cavity. Once in the membrane cavity, the feed water flows tangentially across the membrane surface. Feed water flow is controlled and is typically laminar depending on the feed spacer and the fluid velocity used. A portion of the feed water permeates the membrane and flows through the permeate carrier, which is located in the cell body top. The permeate flows to the center of the cell body top, is collected in another manifold, and then flows out through the permeate outlet connection into the permeate collection vessel. The concentrate stream, which contains the material rejected by the membrane, continues sweeping over the membrane and collects in the manifold. The concentrate then flows through the concentrate flow control valve into the feed vessel. U.S. Pat. No. 4,846,970 describes such a cross-flow membrane cell, the teachings of which are incorporated herein by reference.

Sodium bicarbonate was added to the feed water as a buffer and the system was run at the experimental parameters for 1 to 2 hours to achieve steady state. After reaching a steady state flux, the feed water in the feed tank or vessel was spiked with the silica additive and/or the alginic acid additive to achieve the concentrations of Table 1 and the experiment continued for a minimum of 70 hours.

A series of experiments were designed varying pressure, velocity, and foulant. These experiments isolated the fouling due to alginic acid and silica separately. In other experiments, silica and alginic acid were added together at the same concentrations and other experimental conditions as the individual foulant experiments. The individual foulant experiments were designed to characterize the behavior of the foulant and collect conductivity, pH, flowrate, and permeate flux data. The concentration of the sodium bicarbonate solution in feed water remained the same at 2 mM. Each experiment employed 0 or 200 mg/L of silica, and 0 or 40 mg/L of the alginic acid in the feed water. The variables included two velocity settings at 0.3 and 0.6 m/s, and pressure settings at 13.8 and 27.6 bar. The temperature and pH was maintained at 25° C. and 8, respectively.

Experiment numbers referred to in the following section and corresponding operating conditions are given in Table 1.

TABLE 1
Operating conditions

| | Cross-flow | | Silica | Alginate |
|---|---|---|---|---|
| | velocity | Pressure | Concentration | concentration |
| Experiment # | [m/s] | [bar] | [mg/l] | [mg/l] |
| 3 | 0.3 | 13.8 | 200 | |
| 6 | 0.6 | 13.8 | 200 | |
| 9 | 0.3 | 27.6 | 200 | |
| 12 | 0.6 | 27.6 | 200 | |
| 1 | 0.3 | 13.8 | | 40 |
| 4 | 0.6 | 13.8 | | 40 |
| 7 | 0.3 | 27.6 | | 40 |
| 10 | 0.6 | 27.6 | | 40 |
| 8 | 0.3 | 27.6 | 200 | 40 |
| 11 | 0.6 | 27.6 | 200 | 40 |

The experiments described above yielded the following results.

### A) Fouling by Silica at Two Velocities and Pressures:

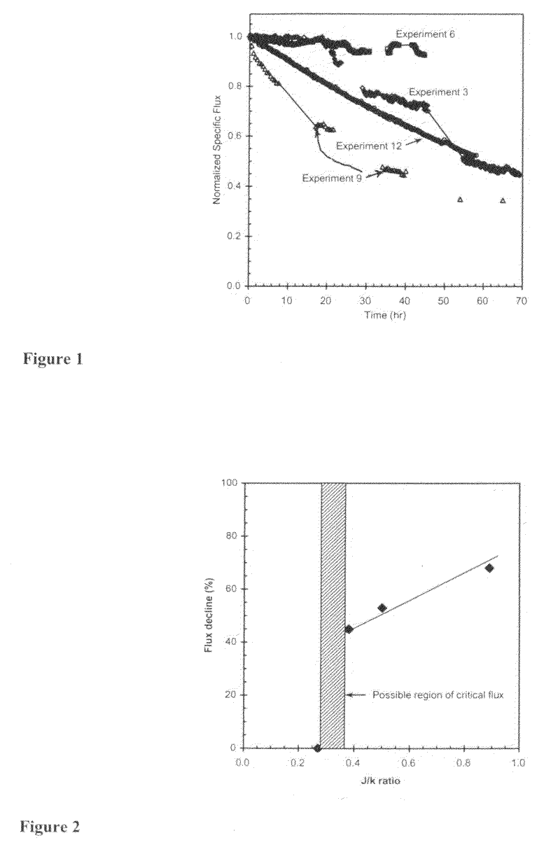

The experiments for silica fouling by itself as seen in FIG. 1 were conducted using a silica concentration of 200 mg/L. Experiments 3 and 6 were run at the pressure of 13.8 bar and Experiments 9 and 12 were run at 27.6 bar. Experiment 3 had a 53 percent decrease in permeate flux over the 70-hour run, whereas Experiment 6 experienced no flux decrease. The results for Experiment 6 demonstrate an application of the critical flux concept presented earlier. The combination of the experimental parameters-velocity, pressure, temperature, pH, and concentration-creates ideal conditions that prevent fouling and allow the system to run for long periods with less fouling. The permeate flux for Experiments 9 and 12 show a gradual decrease over the duration. Experiment 9 had a 68 percent decrease in permeate flux. Experiment 12 had a 45 percent decrease in permeate flux. This is a 23 percent difference between the two experiments. Although both experiments were run at 27.6 bar, the velocity for Experiment 12 was twice as high, increasing shear stress and thereby improving the permeate flux drop in comparison to Experiment 9. FIG. 1 shows silica fouling can occur under various conditions.

The influence of pressure and velocity on silica fouling is shown in Table 2. The parameters k_{cp}; J_{w}; and J/k are described in the attached Appendix. Three of the four silica experiments show a decline in flux with the exception of Experiment 6 indicated by the low J/k value and 0 percent flux decline. Experiment 6, with crossflow velocity 0.3 m/s and pressure 13.8 bar, has a calculated J/k ratio of 0.27 indicating the lowest ratio of foulant transport to the membrane surface. The behavior is attributed to the combination of velocity, pressure, and silica concentration creating a 0 percent decline in flux. The relationship between the J/k ratio, flux decline, and critical flux is explored in more detail in FIG. 2 and it has been observed that J/k ratio is a good indicator of flux decline A distinct relationship exists between the J/k ratio and the extent of flux decline in these experiments, until the critical flux is reached. Below that point, no fouling occurred in these experiments. The critical flux appears to occur at a J/k ratio between 0.27 and 0.38 for these experiments. The importance of J/k ratio, as opposed to just flux, is particularly evident by comparing the flux in Experiments 3 and 12 in Table 2. Although Experiment 12 had a higher initial flux, it had a lower flux decline than Experiment 3 because it had a lower J/k ratio.

TABLE 2
Critical flux and J/k ratio of silica experiments

| | | | Mass | | | |
|---|---|---|---|---|---|---|
| | Cross-flow | | transfer | | Initial | Flux |
| Experiment | velocity | Pressure | coefficient, | Initial flux, | J/k ratio | decline |
| # | [m/s] | [bar] | k_{cp} [m/s] | J_{W} [m/s] | [-] | [%] |
| 3 | 0.3 | 13.8 | 2.73 × 10 − 5 | 1.24 × 10 − 5 | 0.50 | 53 |
| 6 | 0.6 | 13.8 | 3.43 × 10 − 5 | 1.18 × 10 ″5 | 0.27 | 0 |
| 9 | 0.3 | 27.6 | 2.73 × 10 − 5 | 2.19 × 10 − 5 | 0.89 | 68 |
| 12 | 0.6 | 27.6 | 3.43 × 10″5 | 1.66 × 10 − 5 | 0.38 | 45 |

### B) Fouling by Alginic Acid at the Same Two Velocities and Pressures:

The experiments for alginic acid fouling by itself were conducted using a concentration of 40 mg/L. Experiments 1 and 4 were run at the pressure of 13.8 bar and Experiments 7 and 10 were run at 27.6 bar. All alginic acid experiments ran for a minimum of 70 hours. The pH of the feed water remained at 8. The addition of the alginic acid to the feed tank or vessel did not change the pH of the water. Little to no flux decline occurred in these experiments.

In a study on alginic acid conducted by Lee et al. (2006), results showed that a decline in flux can be expected as the pH decreases, and no decline in flux will occur at a neutral pH. One particular set of experiments in that work compared the flux at pH values of 3, 6, and 9 over a 20-hour period. No decrease in permeate flux occurred when the pH was at 9 but a considerable drop occurred when the pH was at 3. Since the experiments in the current research were conducted at pH=8, these results agree with Lee's results. The results also agree with studies on alginic acid gels that show that gel formation occurs with the lowering of pH (Draget et al., 1994). The permeate flux was not affected by velocity or pressure.

### C) Combined Silica and Alginic Acid at the Same Concentrations Velocities and Pressures:

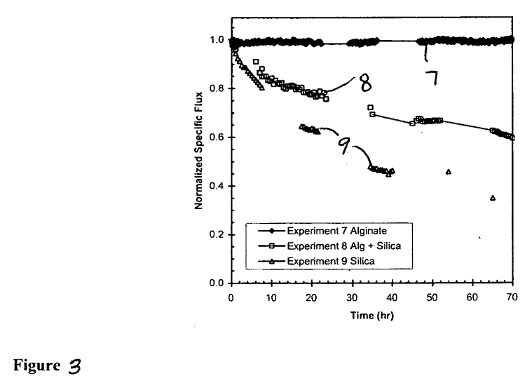

Experiments 7, 8, and 9 used feed solutions of alginic acid by itself, combined alginic acid and silica, and silica by itself, respectively. The operating conditions were a crossflow velocity of 0.3 m/s and pressure of 27.6 bar. The flux decline in these experiments is shown in FIG. 3. The silica fouling experiment (Experiment 9) shows a 68 percent decrease in permeate flux, whereas the combined foulant experiment (Experiment 8) shows only a 26 percent decrease in permeate flux, demonstrating that the combination of the two foulants reduced the flux decline.

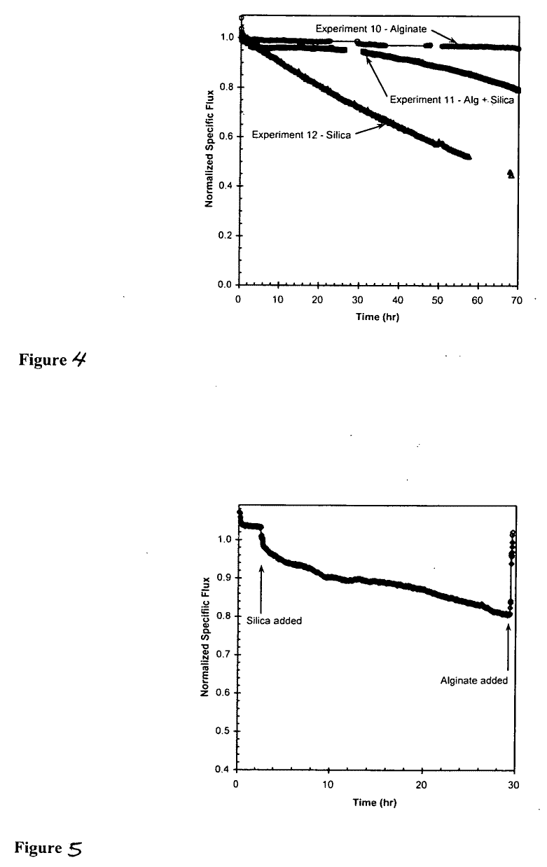

Similar results were observed at higher cross-flow velocity. Experiments 10, 11, and 12 were run at operating conditions of 0.6 m/s and 27.6 bar using alginic acid by itself, combined alginic acid and silica, and silica by itself, respectively. The flux results are shown in FIG. 4. The results are similar to Experiments 7, 8, and 9 for the individual and combined foulant experiments. Silica fouling, Experiment 12, shows a decrease of 45 percent, whereas the combination of the foulants in Experiment 11 shows a decrease of 22 percent in permeate flux. Again, the results demonstrate that the combination of the silica and alginic acid reduced the flux decline.

Furthermore, the results were similar for the alginic acid by itself, silica by itself and combination foulants for the experiments run at high pressure. The alginic acid fouling Experiments 7 and 10 remained steady despite the velocity of the feed water. The combination foulant Experiments 8 and 11 showed a steady decrease in permeate flux. At the lower velocity, Experiment 8 showed a decrease of 26 percent, whereas Experiment 11, at the higher velocity, showed a decrease of 22 percent.

The individual foulant Experiments 9 and 12 also had similar results, in that they both showed a steady decline in flux. By comparison, Experiment 9, conducted at the lower velocity, showed a greater flux drop of 68 percent, and Experiment 12 showed a flux drop of 45 percent.

D) Removing Silica Fouling with Alginic Acid

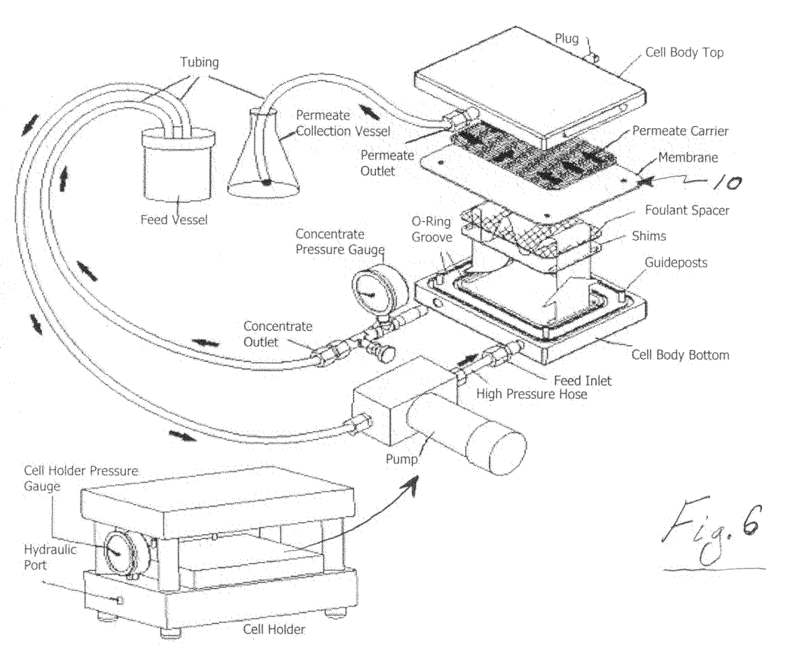

The experiments described above demonstrate that the feed water containing both alginic acid and silica exhibited less fouling than feed water with only silica, indicating that alginic acid acts to reduce the fouling that would be caused by silica. Separate experiments were conducted to investigate whether alginic acid can also be able to remove silica that has already fouled a membrane. The feed water was spiked with 200-300 mg/L of silica (added to the feed tank or vessel, FIG. 6) and allowed to run for about 28 hours. The permeate flux dropped by over 20 indicating silica fouling on the RO membrane. After about 28 hours, 80 mg/L of the alignate was also added to the feed water in the feed vessel and within a few hours the permeate flux had increased, indicating that silica had been removed from the membrane. FIG. 5 shows the permeate flux declining by over 20 percent during 28 hours of operation with silica in the feed water. After approximately 28 hours of operation, 80 mg/L of alginic acid was added to the feed tank or vessel and immediately restored permeate flux to the original value.

The increase in flux indicates that the addition of alginic acid reversed the silica fouling on the membrane and greatly increased the permeate flux. The experiment also shows that silica fouling, in the combination foulant experiments, is inhibited by alginic acid. Furthermore, the results from the cleaning experiments demonstrate that alginic acid can remove silica from reverse osmosis membranes after fouling has occurred and restore permeate flux.

### E) Feed Water Conductivity:

The conductivity values ranged from 10-20 μS/cm for all of the RO treated water measured before use in the experiments. As the sodium bicarbonate was added to the feed water, the conductivity increased to greater than 200 μS/cm. After the sodium bicarbonate was added, the system ran for 1-2 hours for stabilization. After stabilization, the experimental chemicals were added to the feed water in the feed tank or vessel. The data acquisition software began collecting conductivity data after the chemicals had been added to the feed tank, therefore the initial conductivity values were recorded. For the alginic acid isolation experiments described above, conductivity of the water did not increase greatly with the initial addition of the alginic acid sodium salt. For the silica isolation experiments described above, conductivity of the feed water showed a significant increase. For example, the experiment 3 feed water conductivity was >200 μS/cm with sodium bicarbonate, and once the silica was added the feed conductivity increased to values greater than 2000 μS/cm. Also, the permeate conductivity showed an increase of values greater than 30 μS/cm. Within one hour, the feed conductivity decreased to 1200 μS/cm, and the permeate conductivity decreased to values less than 5 μS/cm and remained low for the duration the experiment. The combination alginic acid/silica experiments provided the most unexpected results. In the initial steps of an experiment, sodium bicarbonate was allowed to stabilize for one hour. Next, the silica (200 mg/l) was added to the feed water. This experiment used a cross-flow velocity of 0.3 m/s and pressure of 13.8 bar. Immediately after, the feed water conductivity quickly increased to over 1200 μS/cm, and within 30 minutes the alginic acid (40 mg/l) was added. The feed water conductivity decreased quickly to less than 1000 μS/cm as soon as the alginic acid was added, indicating a possible reaction between the alginic acid and silica. The permeate conductivity also showed a decrease within minutes of the addition of alginic acid to the feed water. In another experiment, sodium bicarbonate was added to the feed tank and allowed to stabilize for one hour. This experiment used a cross-flow velocity of 0.6 m/s and pressure of 13.8 bar. Then, the experimental chemicals were added but in the reverse order of the preceding experiment; i.e. the alginic acid and the silica were added in reverse order to better understand synergistic behavior and effects on conductivity. The alginic acid (40 mg/i) was added first. The silica (200 mg/l ) was then added and the feed conductivity increased from 216 μS/cm to slightly over 1000 μS/cm while the permeate conductivity increased from 0 to 8 μS/cm. This illustrates that a reaction between silica and alginic acid was occurring in the feed tank before recording of the experimental data. Alginic acid decreases the conductivity of the silica solution.

Practice of the present invention is advantageous to provide a reduction in the costs of membrane replacement for industries that currently can afford the expense of reverse osmosis water treatment, and will enable other industries, municipalities, nationally and internationally, i.e., drought ridden 3^{rd}-world countries, affordable access to clean water.

### APPENDIX

### Critical Flux

Critical flux has been defined as a condition where the cross-flow velocity parallel to the membrane surface creates sufficient shear and mass transfer (via shear-enhanced diffusion) that foulants are moved away from the membrane surface at a rate greater than the drag of foulants to the membrane surface due to the permeate flux. Therefore, foulants do not accumulate at the membrane surface and irreversible fouling is prevented. Many articles in scientific journals have explored the concept in theoretical terms, and many others have experimentally measured the critical flux for specific well-characterized solutions (Bacchin, et al., 2006). Unfortunately, methods to predict critical flux of a complex solution such as natural water based on measurable water quality parameters have not been developed. Amy et al. (2001) offered a more pragmatic approach, comparing experimental data by evaluating the “J/k ratio,” where J is the permeate flux (Jw) that characterizes the flux of water toward the membrane surface, and k is the concentration polarization mass transfer coefficient (kcp) that characterizes the flux of foulants away from the membrane surface. The flux of the water and flux of the solute is taken from experimental data to calculate the concentration of silica in the permeate by the equation:

Js=CpJ_{w} (1)

Js=mass flux of solute, mg/m²-h
Cp=permeate concentration of solute, mg/L
Jw=volumetric flux of water, L/m²-h

When foulants are not accumulating on the membrane surface, a mass balance on the boundary layer near the membrane surface is at steady state, the accumulation term is zero, and the mass balance equation is:

{dM/dt}=0=J_{w}Ca−D_{L}{dC/dz}a−J_{w}Cₚa (2)

Jw=flux of the water
M=mass of solute
t=time
D_{L}=diffusion coefficient for solute in water
C=concentration of feed water
Cp=concentration of permeate
z=distance perpendicular to membrane surface
a=area of membrane

After some algebraic rearranging and integration of Equation 2:

{(C_{M}−C_{P})/(C_{FC}−C_{P})=e^{Jwδ=e}^{Jw/kcp} (3)

C_{M}=concentration of salt at membrane
C_{FC}=concentration of salt at feed channel
k_{CP}=concentration polarization mass transfer coefficient (δb/DL)
δb=boundary layer

As shown in Equation 3, the J/k ratio can characterize the increase in foulant concentration at the membrane surface. The J/k ratio is used herein to explain the results of some experiments described above (see Table 2).

### REFERENCES

Amy, G., J. Cho, Y. Yoon, and S. Wright. (2001). NOM Rejection by, and Fouling of, NF and OF Membranes. AWWA Research Foundation and American Water Works Association.
Anwar, H., J. L. Strap, J. W. Costerton. (1992). Minireview. Establishment of Aging Biofilms: Possible Mechanism of Bacterial Resistance to Antimicrobial Therapy. Antimicrobial Agents and Chemotherapy. 1347-1351.
Bacchin, P., P. Aimar, and R. W. Field. (2006). Critical and sustainable fluxes: Theory, experiments and applications. Journal of Membrane Science, 281, 42-60.
Callister, W. D., Jr., (1997). Materials Science and Engineering An Introduction, 4th edition. John Wiley & Sons, Inc.
Costerton, J. W., K. J. Cheng, G. G. Geesy, T. I. Ladd, J. C. Nickel, M. Dasgupta, T. J. Marrie. (1987). Bacterial Biofilms in Nature and Disease. Annual Review Microbiology. Vol. 41. P. 435.
Crittenden, J. C., R. R. Rhodes, D. W. Hand, K. J. Howe, and G. Tchobanoglous. (2005). Water Treatment: Principles and Design, 2nd edition.
Davis, D. G., and G. G. Gessey. (1995). Regulation of the alginate biosynthesis gene algC in Pseudomonas aeruginosa during biofilm development in continuous culture. Appl. Environ. Microbiol. 61, 860-867.
Draget, K. I., G. Skjak-Braek, G., O. Smidsrod. (1994). Alginic acid gels: the effect of alginate chemical composition and molecular weight. Carbohydrate Polymers, 25, 31-38.
Draget, K. I., G. Skjak-Braek, G., O. Smidsrod. (1997). Alginate based new materials. International Journal of Biological Macromolecules, 21, 47-55.
Dunne, W. Michael, Jr., (2002). Bacterial Adhesion: Seen Any Good Biofilms Lately? American Society for Microbiology, 15, 2, 155.
Freeman, S. D. N. and R. J. Majerle. (1995). Silica fouling revisited. Desalination, 103, 113-115.
Hamrouni, B., M. Dhahbi. (2001). Analytical aspects of silica in saline waters-application to desalination of brackish waters. Desalination, 136, 225-232.
Heukelekian, H., and A. Heller. (1940). Relation between food concentration and surface for bacterial growth. Journal of Bacteriology, 40, 546-558.
Lee, S, W. S Ang, and M. Elimelech. (2006). Fouling of reverse osmosis membranes by hydrophilic organic matter: implications for water reuse. Desalination, 187, 313-321.
Lisitsin, D., Hassan, D., Semiat, R. Critical flux detection in a silica scaling RO system. 2005, 186, 311-318.
Mavredaki, E. E. Neofotistou, and K. D. Demadis. (2005). Inhibition and Dissolution as dual Mitigation Approaches for Colloidal Silica Fouling and Deposition in Process Water systems: functional Synergies. Industrial Engineering Chem. Res. 44, 7019-7026.
Nederlof, M. M., H. Prummel, A. Diepeveen, M. Boorsma, R. de Valk, and R. Jong. (2005). Biofouling control on RO membranes by dosing anti-fouling chemicals. AWWA—Membrane Tech. Con.
Ng, H,Y. (2005). RO membrane solute rejection behavior at the initial stage of colloidal fouling. Desalination, 174, 211-217.
Scheikholeslami, R., and S. Tan. (1999). Effects of water quality on silica fouling of desalination plants. Desalination, 126, 267-280.
Scheikholeslami, R, S., S. Zhou. (2000). Performance of RO membranes in silica bearing waters. Desalination, 132, 337-344.
Semiat, R., I. Sutzkover, D. Hassan. (2003). Scaling of RO membranes from silica supersaturated solutions. Desalination, 157, 1-3, 169-191.
Weng, P. F. (1995). Silica scale inhibition and colloidal silica dispersion for reverse osmosis systems. Desalination, 103, 59-67.

Although the invention has been described above in connection with certain embodiments thereof, those skilled in the art will appreciate that the invention is not limited to these embodiments and that changes and modifications can be made therein without departing from the spirit and scope of the invention as set forth in the appended claims.

1. A method of controlling fouling of a reverse osmosis membrane disposed in an aqueous medium by an inorganic foulant, comprising providing a fouling control agent comprising an acidic polysaccharide in the aqueous medium.

2. The method of claim 1 wherein the fouling control agent is provided in the aqueous medium in an amount effective to reduce, reverse, or prevent fouling by an inorganic foulant.

3. The method of claim 1 wherein the fouling control agent comprises an exopolysaccharide.

4. The method of claim 1 wherein an alginic acid fouling control agent is provided.

5. The method of claim 4 wherein the alginic acid fouling control agent comprises alginic acid salt.

6. The method of claim 5 wherein the alginic acid salt comprises alginic acid sodium salt.

7. The method of claim 1 wherein the foulant comprises a silicon compound.

8. The method of claim 6 wherein the silicon compound comprises silica.

9. The method of claim 1 wherein the fouling control agent is introduced into the aqueous medium after the membrane is at least partially fouled.

10. The method of claim 1 wherein the fouling control agent is introduced into the aqueous medium before it contacts the membrane.

11. The method of claim 4 wherein the fouling control agent is present in an amount of at least about 40 mg/L of the aqueous medium.

12. The method of claim 11 wherein the fouling control agent is present in an amount of at least about 80 mg/L of the aqueous medium.

13. The method of claim 12 wherein the inorganic foulant is present as silica in an amount up to about 200 mg/L of the aqueous medium.

14. The method of claim 1 wherein pressure is about 14 bar to about 28 bar.

15. The method of claim 1 wherein cross-flow velocity is about 0.3 m/s to about 0.6 m/s.

16. A method of controlling deposition or scaling of an inorganic material in an aqueous medium, comprising providing an acidic polysaccharide in the aqueous medium.

17. The method of claim 16 wherein the inorganic material comprises silica or silicon containing material.

18. The method of claim 16 wherein the acidic polysaccharide is provided in the aqueous medium in an amount effective to reduce, reverse, or prevent fouling by the inorganic material.

19. The method of claim 16 wherein the acidic polysaccharide comprises alginic acid.

20. The method of claim 19 wherein the alginic acid comprises alginic acid salt.
